(19) United States
(12) Patent Application Publication
(10) Pub. No.: US 2007/0023981 A1
(43) Pub. Date: Feb. 1, 2007

(54) Gas spring system with centrally guided tubular rolling bellows

(76) Inventor: Norbert Helmling, Bollingen (DE)

Correspondence Address: KLAUS J. BACH, 4407 TWIN OAKS DRIVE, MURRYSVILLE, PA, 15668, US

(21) Appl. No.: 11/522,492

(22) Filed: Sep. 15, 2006

Related U.S. Application Data
(63) Continuation-in-part of application No. PCT/EP05/02649, filed on Mar. 11, 2005.

(30) Foreign Application Priority Data
Mar. 19, 2004 (DE) 10 2004 012 881.2

(51) Int. Cl. F16F 9/14

(52) U.S. Cl. 267/64.15

(57) ABSTRACT

In a gas spring system for wheel suspensions including a tubular rolling bellows which is arranged between a wheel-carrying element and the vehicle superstructure and is mounted between a support element and a roll-on piston which includes a pressure-tight hollow space, the supporting element and the roll-on piston being guided on one another via a central thrust member, a control tube is arranged on the support element and provided with cross-over flow passages and the hollow space of the roll-on piston has a control collar which engages, with control play, the control tube at least in regions of the stroke for controlling the gas flow between the bellow interior and the hollow space as a function of the suspension stroke.

This is a Continuation-In-Part Application of pending International Application PCT/EP2005/003649 filed Mar. 11, 2005 and claiming the priority of German patent application 10 2004 012 881.2 filed Mar. 16, 2004.

### BACKGROUND OF THE INVENTION

The invention relates to a gas spring system for supporting wheel suspension systems or axles on a vehicle superstructure, having a tubular rolling bellows which is arranged between a wheel-carrying or wheel-guiding component and the vehicle superstructure, which tubular rolling bellows is mounted between a support element and a rolling piston which includes a pressure-tight hollow space, the supporting element and the rolling piston being guided on one another via a central thrust member.

DE 35 26 156 A1 discloses a spring damper system having a thrust joint and a pressure-tight, hollow rolling piston. In this spring damper system, the rolling piston is in communication pneumatically in a permanent manner with the rolling piston space via a small hole.

It is the object of the present invention to provide a combined gas spring shock absorber system which contains a displacer which changes its gas displacement volume in a simple manner as a function of the suspension stroke. The system should be inexpensive, low-maintenance and reliable.

### SUMMARY OF THE INVENTION

In a gas spring system for wheel suspensions having a tubular rolling bellows which is arranged between a wheel-carrying element and the vehicle superstructure and is mounted between a support element and a roll-on piston which includes a pressure-tight hollow space, the support element and the roll-on piston being guided on one another via a central thrust member, a control tube is arranged on the support element and provided with crossover flow passages and the hollow space of the roll-on piston has a control collar which engages, with control play, the control tube at least in regions of the stroke for controlling the gas flow between the bellows interior and the hollow space as a function of the suspension stroke.

The control tube which dips into the rolling piston during compression of the suspension acts as a pneumatic valve slide which interconnects or separates the gas volumes of the rolling diaphragm and the rolling piston hollow space as a function of the spring path. The roll-on piston is accurately guided by way of the piston rod which is fixed on the axle side or the wheel suspension. The shock absorber which is pivotally attached to the vehicle superstructure, is accurately guided and carries the rolling piston which makes the valve slide function of the control tube possible in a simple manner. Instead of the shock absorber, a pin which is guided in the bore of the control tube and is mounted on the axle side or the wheel suspension side and carries the rolling piston may be used.

If, for example, what is known as a groove shock absorber is used as thrust member, that is to say a damper which has one or more groove-shaped crossflow channels for example on the inner face of the cylinder wall guiding the piston, the damper force can be adapted to the spring stiffness via the spring stroke. Here, the groove length and position of the crossflow channel in the damper then corresponds to that region of the control tube which is waisted or equipped with grooves.

The invention will become more readily apparent from the following description of an exemplary embodiment thereof shown diagrammatically in the accompanying drawings:

### BRIEF DESCRIPTION OF THE DRAWINGS

FIG. 1 shows a gas spring system having a tubular rolling bellows and an inner guide structure in center position;

FIG. 2 shows the spring system of FIG. 1 in the compressed position;

FIG. 3 shows the spring system of FIG. 1 in the extended position;

FIG. 4 shows a control tube having four wide grooves beads;

FIG. 5 shows the control tube of FIG. 4 in a cross-sectional view;

FIG. 6 shows a control tube having a waist;

FIG. 7 is a cross-sectional view of the control tube of FIG. 6;

FIG. 8 shows a control tube having four inclined grooves;

FIG. 9 shows, in a cross sectional view, the control tube of FIG. 8;

FIG. 10 shows a control tube having four narrow grooves;

FIG. 11 is a cross-sectional view of the control tube of FIG. 10; and

FIG. 12 shows a control tube having channels disposed on the inside of the control tube.

### DESCRIPTION OF PREFERRED EMBODIMENTS

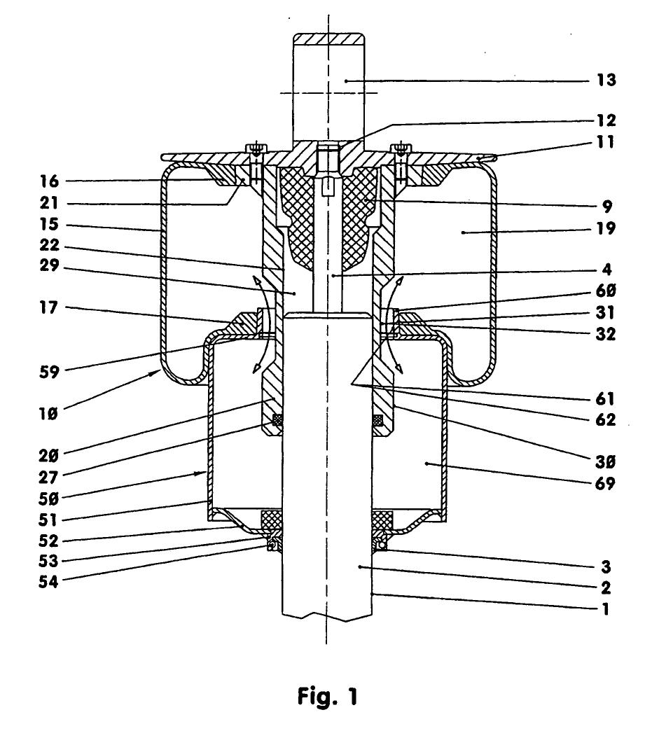

FIGS. 1 to 3 show a gas spring system which is installed generally in motor vehicles, for example, for each suspended wheel between the vehicle superstructure and the axle or respectively, the corresponding independent wheel suspension means.

In the exemplary embodiment, the pneumatic displacer (10) which assumes the spring function is arranged around a hydraulic shock absorber (1). Here, the shock absorber (1) has, inter alia, the function of a thrust member which ensures the precise relative movement of the suspension components during compression and rebound.

The displacer (10) comprises, inter alia, a support element (11), a roll-off piston (50) and a tubular rolling bellows (15) which interconnects both parts.

FIGS. 1 to 3 show the damper tube (2) and the piston rod (4) of the shock absorber (1). Within the gas spring system, the piston rod (4) is screwed with its upper free end into a central threaded hole (12) of the supporting element (11) or the head plate. A bearing bushing (13) is formed integrally on the head plate (11) above the threaded hole (12). The gas spring system is supported in an articulated manner on the vehicle superstructure via this bearing bushing (13). The articulated connection on the wheel suspension or the axle takes place, for example, via a bearing socket which is fastened to the lower end of the damper tube (2). Said bearing bushing is not shown here.

An elastomer stop buffer (9) is seated below the head plate (11) on the piston rod (4) as a stroke limiting means of the damper (1).

The head plate (11) is substantially a round flat disk, on which the tubular rolling bellows (15) is supported with its upper region. A control tube (20) is screwed via an integrally formed flange (21) to the head plate (11), for example centrally. The upper beading (16) of the tubular rolling bellows (15) bears against the outer edge of the flange (21) which is centered on the head plate (11).

The control tube (20) which has the function of a valve element within the gas spring system has a central passage (22). In the exemplary embodiment, the control tube (20) slides with the wall of this passage (22) along the outer surface of the damper tube (2). The movement clearance is sealed by a sealing element (27). In this case, the inner space (29) of the control tube (20) has a venting means (not shown here) to the ambient.

As an alternative, the diameter of the passage (22) can be considerably greater than the outer diameter of the tube (2) of the damper (1). In that case, the volume of the inner space (29) is then added to the hollow space volume of the rolling piston (50).

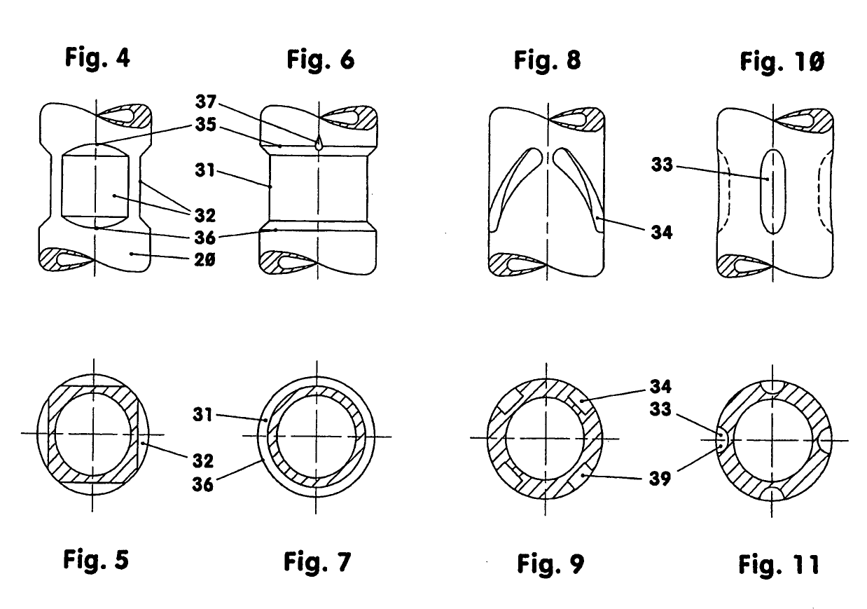

According to FIGS. 1 to 3, the outer wall (30) of the control tube (20) has four grooves (32) or flattened portions in the central region, see also FIGS. 4 and 5. According to FIGS. 6 and 7, a contiguous, circumferential waist area (31) can also be machined into the outer wall (30) instead of the flattened portions (32). In FIGS. 8 and 9, channels (34) which are wound helically inclined are provided in the outer wall (30) and have, for example, a rectangular individual cross-sectional profile forming a further variant, adjacent channels having, for example, opposite pitches. Channels or grooves (33) having a semi-circular individual cross section are shown in FIGS. 10 and 11.

At least part of the edges of the waist area (31), the grooves (32, 33) and the channels (28, 34), and if applicable the groove edges (43, 44), can be rounded and/or polished, in order to minimize flow resistances. The ratio between the cross-sectional area and the cross-sectional circumference should also be as great as possible.

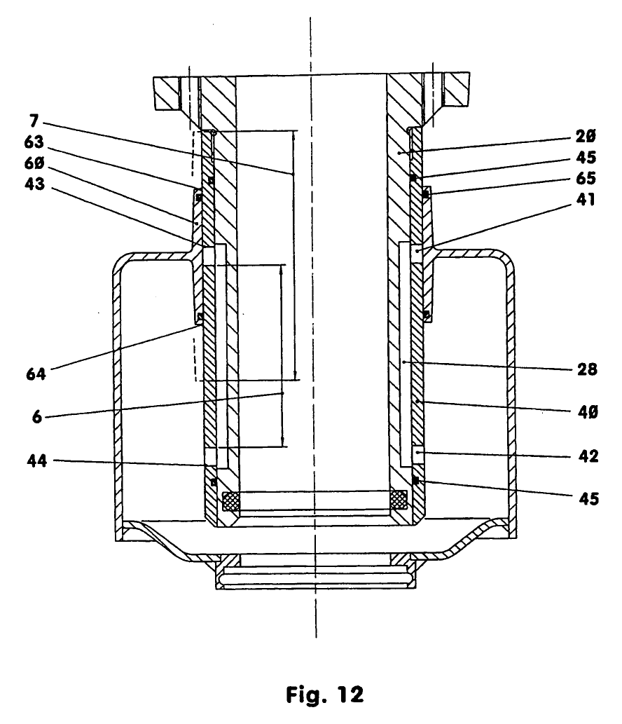

In the control tube (20) according to FIG. 12 internal channels (28) are used instead of the grooves (32, 33), waists (31) and channels (34) which are disposed on the outside. For this purpose, the control tube (20) is of double-walled construction in the control region, for example by means of a sleeve (40). The sleeve (40) is screwed onto the control tube (20), so as to be sealed, for example, via two sealing rings (45). The sliding sleeve (40) has, for example, a multiplicity of radial holes (41), slots or other recesses in the upper and lower regions. The lower recesses (42) communicate with the upper openings (41) via a circumferential annular groove (28) or individual channels which are optionally in communication with one another. There can also be annular grooves and/or channels in the inner wall of the sliding sleeve (40) in order to increase the channel cross sections.

The roll-on bellows support piston (50) is a bush-shaped hollow body which is open at the bottom. The hollow body has a, for example, cylindrical wall (51), inter alia for supporting the tubular rolling bellows (15). The hollow body is closed with a cover (52) which is welded in and, for example, arched downward. The cover (52) has a central hole which is reinforced by means of a mounting flange (53), cf. FIG. 12. The mounting flange (53) rests on the disk flange (3) which is welded to the damper outer tube (2). The roll-on piston (50) is held there with the aid of a spring ring (54).

A seal is arranged between the disk flange (3) and the mounting flange (53), with the result that the rollon piston (50) is fastened to the outer tube (2) of the damper (1) in a gastight manner.

The upwardly oriented base (59) of the rollon piston (50) has, for example, likewise a central opening which is provided with a tubular control collar (60). The latter protrudes upward beyond the base (59) at least to the extent that it can form a radial rest for the lower beading (17) of the tubular rolling bellows (15).

The hole (61) of the control collar (60) has an internal diameter which is slightly greater than the diameter of the outer wall (30) of the control tube (20). Together with the control tube (20), the control collar (60) forms a longitudinal slide valve. For example, at least one annular groove for accommodating a sealing element (65) is situated in the hole (61). This sealing element (65) is, for example, an O-ring, a piston sealing ring or the like.

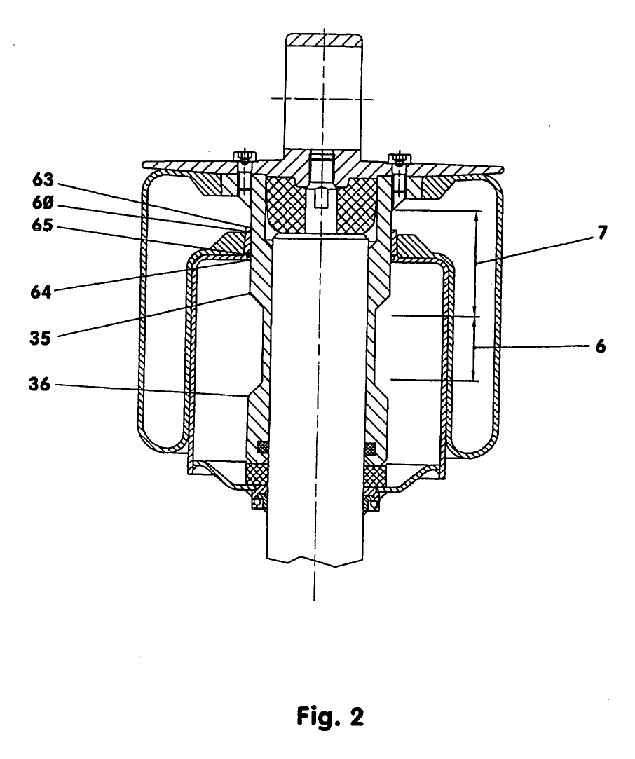

In the illustration according to FIG. 1, the control collar (60) is situated in the region of the grooves (32) or the waist (31), what is known as the comfort stroke region (6), cf. FIG. 2. The cross sections of the waist (31), the cross-sectional sum of the grooves (32, 33) or the cross-sectional sum of the channels (34) reduce the control tube cross section by what is known as a crossflow cross section. The latter are the regions which are not hatched and lie on the outside in FIGS. 5, 7, 9 and 11. The area of the crossflow cross section is between 5 and 20% of the maximum cross-sectional area of the diaphragm space (19) in the mounted state.

The upper control edge (63) and the lower control edge (64) of the control collar (60) are at a spacing which is smaller than the spacing between those regions of the control edges (35, 36) on the control tube (20) which lie furthest apart from one another. These spacings are measured in each case in the stroke direction. Here, the control collar (60) cannot cover the waist (31), the grooves (32, 33) or the channels (34) completely. In FIGS. 1 to 11, the control collar (60) therefore has negative control coverage. As a consequence, the gas of the bellows space (19) communicates with the gas of the hollow space (69) in a spring stroke region (6), in which both control edges (63, 64) of the control collar (60) remain within the region between the upper control edge (35) and lower control edge (36) of the control tube (20), plus a minimum spacing. As a result, the spring stiffness is relatively low, with the result that comfortable driving is possible on a roadway which is constructed satisfactorily. The dimension of the minimum spacing is calculated from the required crossflow cross section.

In order to reduce the wear of the seals (65) in the control collar (60), the grooves or channels (34) are arranged, for example, obliquely, cf. FIG. 8.

In the construction according to FIG. 12, the described communication is likewise achieved in the comfort stroke region (6) , as long as the upper control edge (63) is below the hole control edges (43) and the lower control edge (64) is above the hole control edges (44). In both variants, the crossflow cross sections are selected with such a large area that no noticeable throttling action occurs in the stroke region (6). As a result, unnecessary heating and disruptive whistling noise can be avoided.

In order not to cause a sudden change in the spring stiffness when contact is made between the opposite control edges (35, 63) and (36, 64), cf. specifically FIGS. 6 and 7, additional precision control edges (37) can be machined in at least a part of the control edges (35), cf. FIG. 6.

If the gas spring system is to be changed over to driving with a higher spring stiffness, first of all the gas amount Is reduced in the bellows space (19). The control collar (60), at least its upper control edge (63), then moves predominantly above the upper control edge (35) or above the upper regions of these control edges in what is known as the sport stroke region (7). In this way, the gas volume which participates in suspension is limited to the gas amount present in the bellows space (19).

The variant of FIG. 12 likewise shows this operating state. The control collar (60) covers the upper holes (41) or the hole control edges (43) for the usual sport stroke region (7). An exchange of gas is therefore prevented with the rolling piston hollow space (69). Here, the control collar (60) acts with positive control coverage.

In both cases, the high spring stiffness ensures reliable wheel guidance on bumpy roadways.

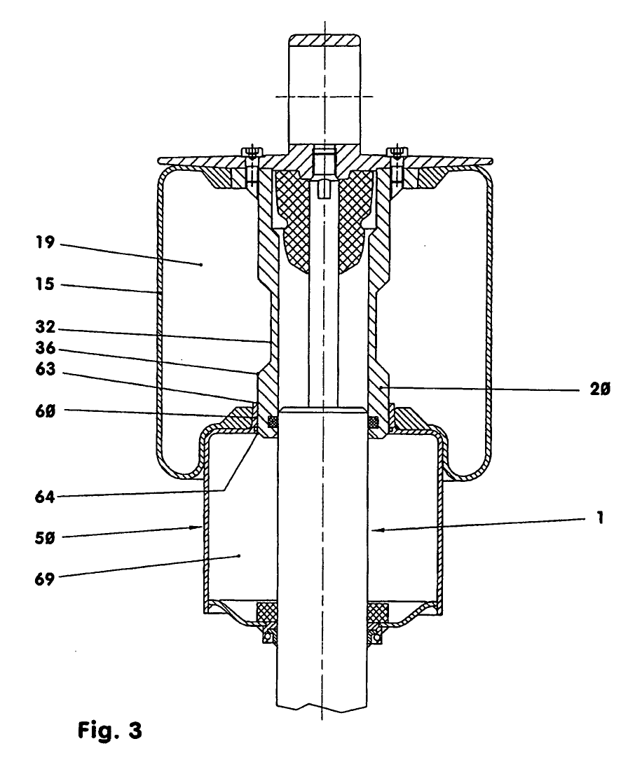

In FIG. 3, the control collar (60) is situated with its upper control edge (63) below the grooves (32). The vehicle superstructure has particularly large ground clearance on account of the tubular rolling bellows (15) being pumped up. The gas volumes of the bellows space (19) and the roll-over piston hollow space (69) are separated from one another, at least if the lower control edge (64) is situated below the control edge (36), as a result of which the spring stiffness is relatively high. This setting can be used optionally for driving off road.

Generally, the bellows space (19) is in communication with a corresponding gas accumulator and/or a compressor system, at least temporarily, via the lines which convey gas and can be shut off. A valve control means and position regulating means complete the gas spring system to form a ride level control means.

In FIGS. 1 to 12, the control tube (20) is described as a regular tube having a cylindrical outer contour and a cylindrical passage (22). The passage wall (62) is likewise shown to be cylindrical. It goes without saying that the cross-section of the control tube (20) can also have a regular or irregular polygonal profile. In addition, it also does not have to be closed completely in cross section. The control tube (20) can also be divided into a plurality of individual tubes or profiles which are arranged next to one another. In all cases, the cross section or the cross sections of the control collar (60) are adapted to this control tube cross section or these control tube cross sections.

It is noted that preferably 40±10% of the overall spring stroke length is provided for the comfort stroke.

Also, the area of the cross-flow cross-section is between 5 and 20% of the maximum cross-sectional area of the bellows space (19)

What is claimed is:

1. A gas spring system for supporting wheel suspensions or axles on a vehicle superstructure, including a tubular rolling bellows arranged between a wheel-support structure and the vehicle superstructure, said tubular rolling bellows being mounted between a support element and a roll-on piston including a pressure-tight hollow space, the support element and the roll-on piston being guided on one another via a central thrust member, a control tube (20) arranged on the support element (11) and including a cross-over area formed by one of a waist area on its outer wall (30) grooves (32, 33) and openings (43, 44) forming channels (28), the hollow space (69) of the roll-on piston (50) having a control collar (60) which extends, with control play, around the control tube (20), at least in regions of the stroke, and which covers the respective one of the waist areas (31), the groove (32, 33) and the openings (43, 44) entirely or partially as a function of the suspension stroke.

2. The gas spring system as claimed in claim 1, wherein the control collar (60) of the roll-on piston (50) engages sealingly the outer wall (30) in a sport stroke region (7), wherein the hollow space (69) is separated from the diaphragm space (19), while said control collar (60) neither throttles nor closes the crossover cross-section in the stroke direction in a comfort stroke region (6).

3. The gas spring system as claimed in claim 2, wherein at least one radially acting sealing element (65) is mounted in the wall (62) of the control collar (60).

4. The gas spring system as claimed in claim 2, wherein the thrust member is a hydraulic shock absorber (1) which is integrated into the gas spring system.

5. The gas spring system as claimed in claim 4, wherein the shock absorber (1) belongs to the group of groove dampers.

6. The gas spring system as claimed in claim 4, wherein the inner wall (22) of the control tube (20) bears sealingly engages the outer surface of the tube (2) of the shock absorber (1), so as to form a slide seal.

7. The gas spring system as claimed in claim 1, wherein the control tube (20) and the control collar (60) are arranged concentrically with respect to the center line of the shock absorber (1).

8. The gas spring system as claimed in claim 1, wherein 40±10% of the overall spring stroke is provided for the comfort stroke (6).

9. The gas spring system as claimed in claim 1, wherein the area of the crossflow cross section is between 5 and 20% of the maximum cross-sectional area of the bellows space (19).

10. The gas spring system as claimed in claim 1, wherein the crossover area is a contiguous flow passage area.
